(19) United States
(12) Patent Application Publication
(10) Pub. No.: US 2007/0180664 A1
(43) Pub. Date: Aug. 9, 2007

(54) Array of clips and a method of installation of said clips

(76) Inventor: Ronald Perry, Gold Coast MC (AU)

Correspondence Address: HOFFMANN & BARON, LLP, 6900 JERICHO TURNPIKE, SYOSSET, NY, 11791, US

(21) Appl. No.: 10/580,880

(22) PCT Filed: Nov. 25, 2004
(86) PCT No.: PCT/AU04/01653

§ 371 Date: Mar. 5, 2007

(30) Foreign Application Priority Data
Nov. 25, 2003 (AU) 2003906491

(51) Int. Cl. F16G 11/00

(52) U.S. Cl. 24/115 R

(57) ABSTRACT

An array of clips (10) comprising: a first clip (20) and a second clip (20); and a connection element (90) extending between the first clip (20) and the second clip (20); each clip (20) having: a channel (50) for location of a elongate member (11), and an abutment fulcrum portion (70) formed on said clip (20); wherein rotation of the first clip (20) with respect to the second clip (20) causes the abutment fulcrum portion (70) of the first clip (20) to abut against the second clip (20) to break said connection element (90).

### FIELD OF THE INVENTION

The present invention relates to an array of clips and a method of installation of said clips. In particular, the invention relates to clips for use in securing electrical cables in a desired location and therefore will be described in this context. However it should be appreciated that other elongate members may be secured using the clip.

### BACKGROUND OF THE INVENTION

Electrical cabling is used throughout the world for both domestic and commercial applications. These cables can be potentially hazardous if they are easily accessed. Therefore, they are often located in roofs and/or floors of buildings. It is necessary to secure these cables so the cables are not damaged when the roof and/or floor of the building is accessed by other people who may accidentally pull or step on the cable.

One popular cable clip includes a U-shaped channel and a nail. The nail extends through the U-shape channel. In order to retain an electric cable in a desired location, a cable is located within the U-shaped channel and the nail is driven into a wall, beam or the like structure. This cable clip is easy to use and cheap.

Typically, a large number of such clips are applied individually to secure a single cable. Unfortunately most cables are located in remote locations such as under houses. Therefore, a large number of cables must be carried by an installer in order to secure the cable.

Accessibility of the clips during installation can therefore be problematic. An installer may hold a number of such clips in the user's mouth. This is potentially dangerous as a clip can be accidentally swallowed. Alternatively, clips can be located in a pocket of the user or in a box. This is generally an inconvenience and often causes delay in accessing clips and hence more time is taken to secure a cable.

### OBJECT OF THE INVENTION

It is an object of the present invention to overcome or alleviate one or more of the above disadvantages or provide the consumer with a useful or commercial choice.

### SUMMARY OF THE INVENTION

According to a first aspect of the present invention, there is provided an array of clips comprising:
a first clip and a second clip; and
a connection element extending between the first clip and the second clip;
each clip having:
   a channel for location of an elongate member, and
   an abutment fulcrum portion formed on said clip;
wherein rotation of the first clip with respect to the second clip causes the abutment fulcrum portion of the first clip to abut against the second clip to break said connection element.

The array of clips is normally produced with using injection moulding.

The channel may be formed from two legs interconnected by a retaining body.

The connection element is normally attached to one of the legs of each of the clips. The connection element may have a notch located adjacent to where the connection element is attached to the clip. The connection element is normally in the form of an attachment lug.

Preferably, at least one of the legs of at least one clip includes a widened portion towards an end of the leg to slightly narrow an open side of the channel.

Preferably, at least one abutment fulcrum portion on at least one clip protrudes from the clip.

At least one abutment fulcrum portion may protrude from at least one leg of each clip. Normally, each leg of the clip has an abutment fulcrum portion. Preferably, the abutment fulcrum portion is in the form of an abutment ear.

Preferably, the retaining body of each clip includes a protruding portion that extends into the channel. Usually, the protruding portion comprises a ridge which stands proud of the retaining body.

Normally a securing member extends through a leg of each of the clips. Preferably, the securing member is a nail.

According to a second aspect of the present invention, there is provided a method of installation of an array of clips, the method including the steps of:

placing an elongate member within a channel of a first clip;

fixing the first clip to a surface to retain the elongate member in a desired position on said surface;

rotating a second clip with respect to the first clip to cause the abutment fulcrum portion, located on either of said first clip or said second clip, to abut against the other of said first clip or said second clip to break a connection element connecting said first clip and said second clip.

The first clip may be separated from the other second clip before or after being fixed to the surface.

Preferably, the method includes use of an array of clips in accordance with the first aspect of the invention.

According to a third aspect of the present invention, there is provided a clip for retaining an elongate member relative to a surface, said clip comprising:
two legs interconnected by retaining body to form a channel;
a securing member extending through at least one of the legs, and
a protruding portion that extends into the channel.

Preferably, the clip is adapted for use with a larger cable having cross-sectional dimensions of about 12 mm by 6 mm.

Preferably, the clip is adapted for use with a smaller cable having cross-sectional dimensions of approximately 9 mm by 4 mm.

Preferably, in use, the distance between the part of the projecting portion which is closest to the surface is approximately equal to the corresponding dimension of the smaller elongate member. In one embodiment, this dimension is approximately 4 mm.

Preferably, in use with the larger elongate member, the projecting portion compresses a dimension of the larger elongate member, at the point of contact, approximately to the size of the corresponding dimension of the smaller elongate member.

Each clip in accordance with the third aspect of the present invention may also form part of an array of clips according to a first aspect of the present invention.

### BRIEF DESCRIPTION OF THE DRAWINGS

Embodiments of an array of clips will now be described, by way of example only, with reference to the accompanying drawings in which:

FIG. 1 is a perspective view of an array of clips according to an embodiment of the invention;

FIG. 2 is a perspective view of two clips joined together

FIG. 3 is a side view of the clips of FIG. 2;

FIG. 4 is an end view of the clips of FIG. 3;

FIG. 5 is a cross-section corresponding to C-C of FIG. 3;

FIG. 6 is a top view of the clips of FIG. 2;

FIG. 7 is a bottom view of the clips of FIG. 2;

FIG. 8 is a sectional side view of a clip;

FIG. 9 is a side view of a clip used to retain a cable of a first size;

FIG. 10 is a side view of a clip used to retain a cable of a second size;

FIG. 11A to 11E show tops views of one clip being removed from an adjacent clip;

FIGS. 12 and 3 are alternative embodiments of attachment lugs; and

FIGS. 14, 15 and 16 are cross-sectional views of alternative embodiments of clips;

### DETAILED DESCRIPTION OF THE INVENTION

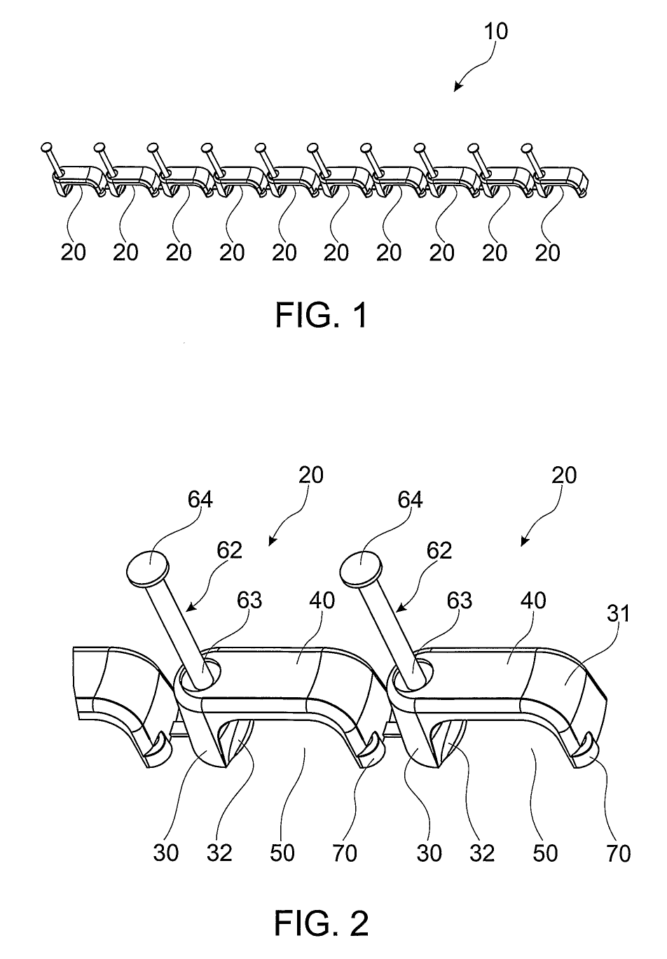

FIG. 1 shows an array of clips 10 for use in attaching cables to a surface such as a wall or beam. The array of clips 10 includes ten clips 20 that are joined together with connection elements in the form of attachment lugs 90.

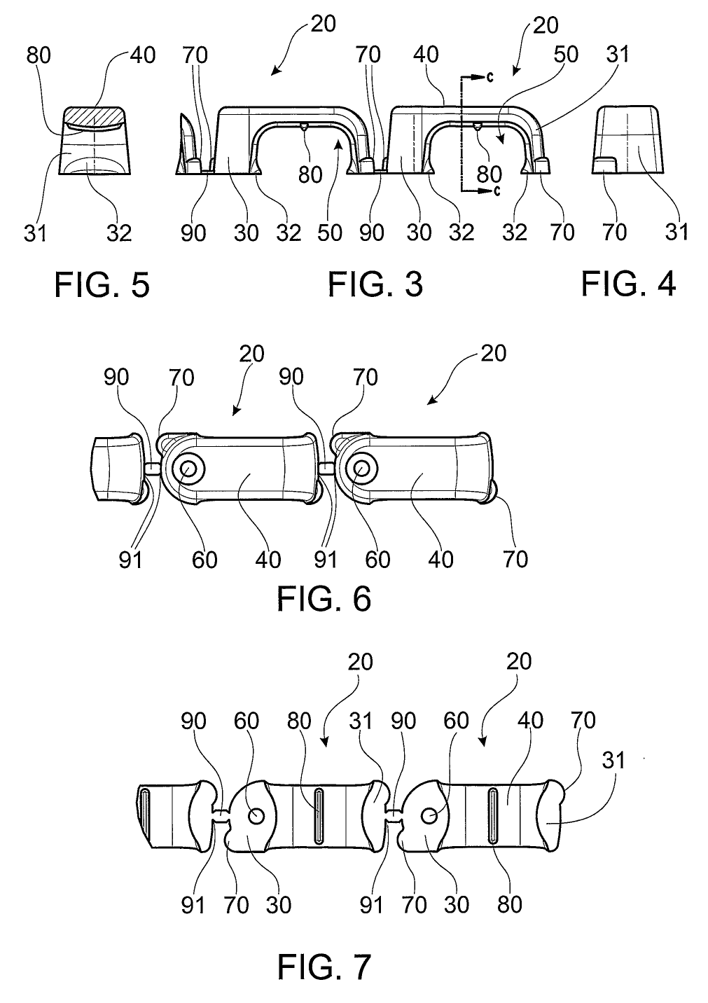

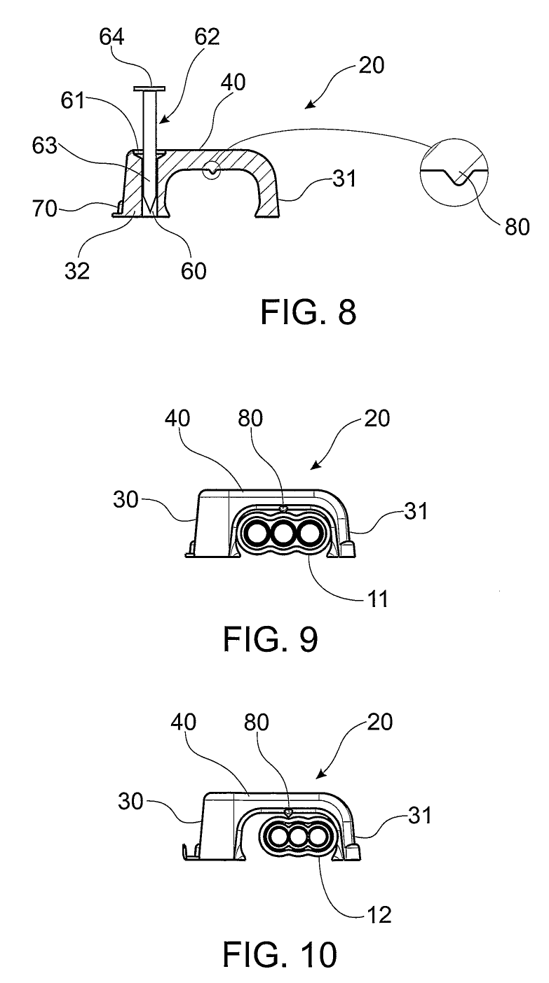

FIGS. 2 to 8 show the clips 20 in more detail. Each clip 20 comprises two legs 30 and 31 interconnected by a retaining body 40 to form a channel 50. Both of the legs 30 and 31 have a widened portion 32 located towards an end of each of the legs 30 and 31, to slightly narrow an open side of the channel 50.

A bore 60 extends through one of the legs 30. A countersink 61 is located at the top of the bore 60 that is wider than the remainder of the bore. A securing member, in the form of a nail 62, extends through the bore. It should be appreciated that other types of securing members may be used such as a screw.

An abutment ear 70 is located on each leg 30 and 31 of the clip 20. The abutment ear 70 is located adjacent respective lower ends of the legs. Abutment ears 70 are located on opposite sides of the legs 30 and 31.

A projection 80, in the form of a ridge, extends into the channel from the retaining body. The projection 80 is tapered and is relatively small.

Each of the clips 20 are connected to an adjacent clip 20 through an associated attachment lug 90. The attachment lug 90 is adapted to retain the clips 20 in a strip during storage but to allow easy manual disconnection of the clips 20 during use.

The attachment lug 90 is relatively thin. A notch 91 is located at each end of the attachment lug adjacent to where the attachment lug 90 is attached to each leg 30 and 31 of the clip 20. The notch 91 is located at an opposite side of the clip 20 where the abutment ear 70 is located.

In use a cable 11 is located within the channel 50 of the clip 20. The widened portion 32 of the two legs 30 and 31 assists in holding the cable 11 within the channel 50. The clip 20 is then located at a desire location such as a wall or beam. FIGS. 9 and 10 show how the clip 20 retains different sized 3-core cables 11 and 12. FIG. 9 illustrates the clip 20 holding a larger 13 mm wide by 6 mm thick cable 11 whilst FIG. 10 illustrates the clip 20 holding a smaller 10 mm wide by 4 mm thick cable 12.

The clip 20 holds the larger cable 11 through the projection 80 contacting and slightly deforming an outer sheath of the larger cable 11 and thereby holding the larger cable 11 in place against a surface. However, when the clip 20 is used with the smaller cable 12, the projection 80 contacts the smaller cable 42 in between a valley located within the outer sheath of the smaller cable 12 and therefore preventing undesirable movement of the smaller cable 12. Thus, provision of the projection 80 allows the illustrated clip to be used effectively with either size of cable 11 or 12. It should be appreciated that in an alternative embodiment, the projection 80 may be a pad of a resilient material so that deformation occurs in the projection rather than the cable 20.

Once the clip 20 and cable 11 are located at a desired position, the nail is then nailed into the wall or beam. During nailing, the nail 62 is moved with respect to the bore 60 located with the leg 30. A head 64 of the nail sits with the countersink 61 after nailing has been completed whilst a body 63 of the nail holds the cable to the wall or beam.

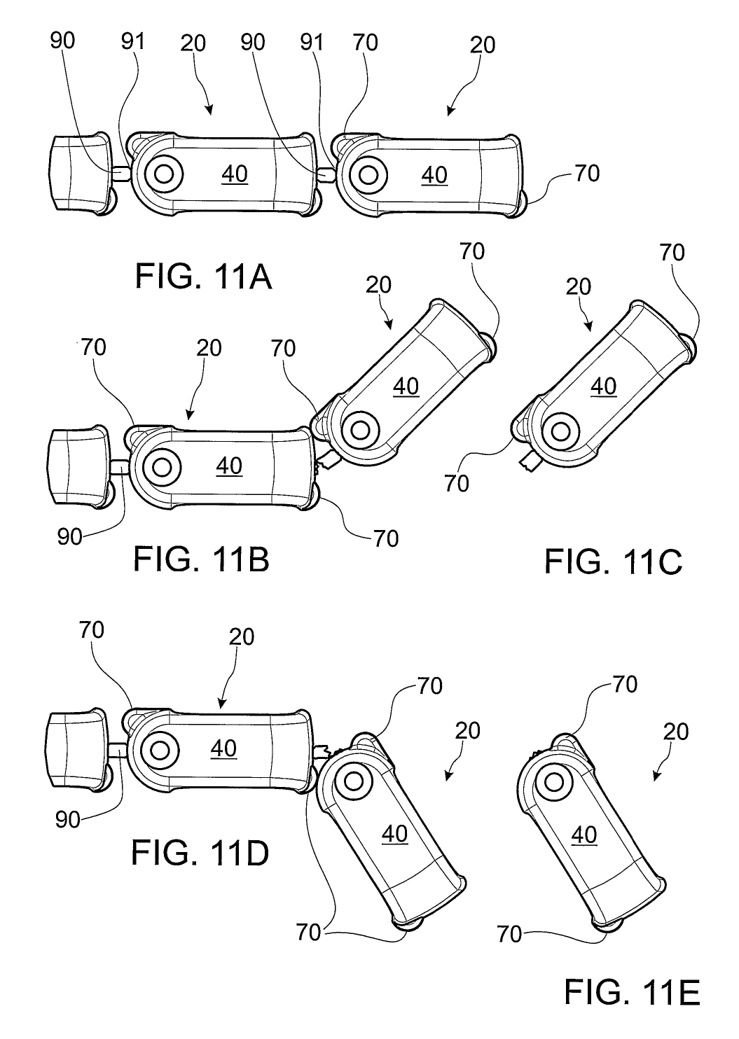

In order to break the attachment lug 90 and remove a clip 20 from an adjacent clip 20, one clip 20 is rotated with respect to an adjacent clip as shown in FIG. 11A to 11E. Upon rotation of one clip 20 with respect to the adjacent clip 20 this causes the abutment ear 70 on one leg 31 of one of the clips 20 to abut against a leg of the other clip. The abutment ear 70 provides a fulcrum in order that the attachment lug 90 tears from the leg it is attached. The notch 91 in the attachment lug 90 assists in tearing of the attachment lug away from the leg. It should be noted that due to the placement of the abutment ears 70 the one clip may be rotated with respect to the other clip in either a clockwise direction shown in FIG. 11D and 11E or anti-clockwise direction shown in FIG. 11B to 11C to break the attachment lug.

The process of breaking the attachment lug 90 may then be repeated, as required, with the rest of the clips 20 of the array. It will be appreciated that unlike the use of clips which are not connected, a user can conveniently hold a considerable number of clips in one hand. In the preferred embodiment, an array of clips includes ten such clips, but clearly the number of clips formed in an array may be selected as desired.

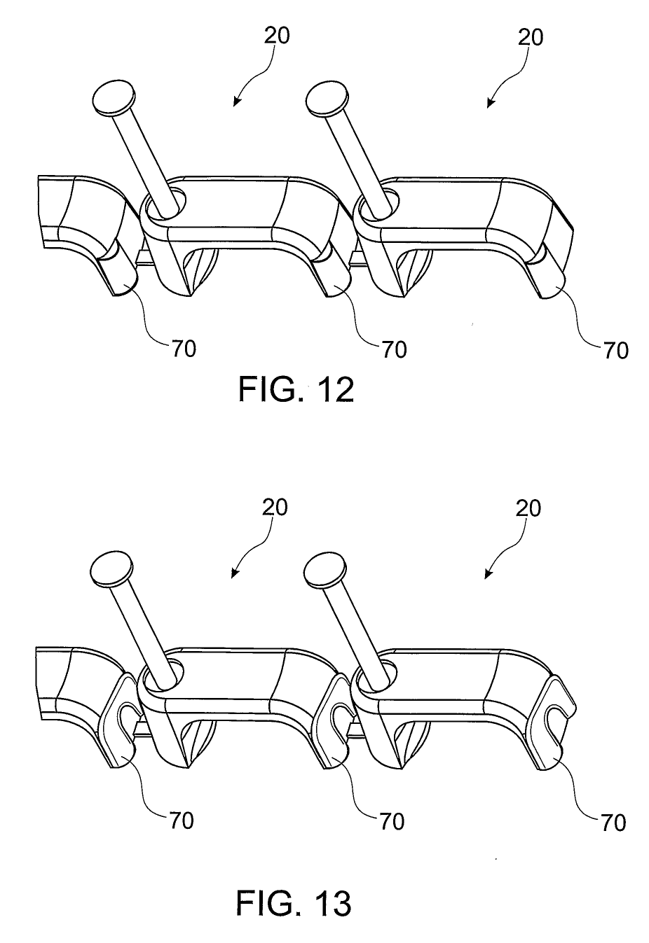

It will be appreciated that many alternatives are possible. For example FIGS. 12 and 13 show variations of the abutment ear 70. FIG. 12 shows the abutment ear 70 extending the length of the leg whilst FIG. 13 shows a U-shaped abutment ear 70. It should be appreciated that the abutment ear 70 provides a fulcrum through which the attachment lug is broken. Therefore, the abutment ear 70 may be of any shape so long as it performs that function.

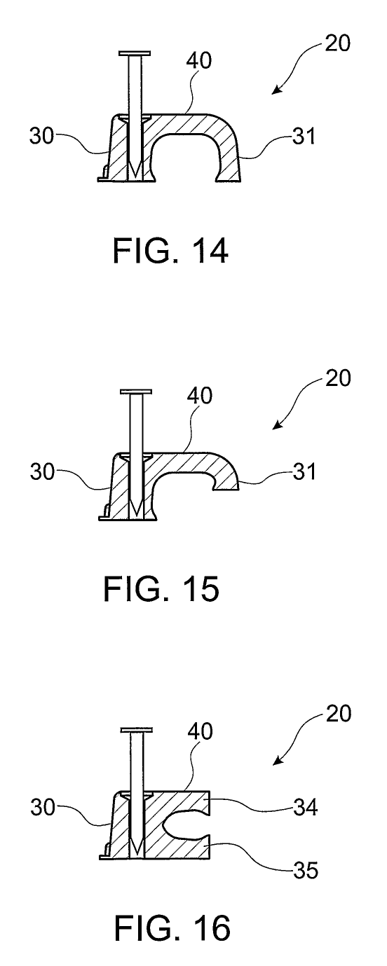

Further alternatives for the shape of the clip 20 are also possible as shown in FIG. 14, FIG. 15 and FIG. 16.

FIG. 14 shows an alternative embodiment for use with an elongate member with generally circular cross-section.

FIG. 15 illustrates an embodiment in which the clip has legs of a different length.

FIG. 16 illustrates an embodiment in which a channel 50 is provided by two arms 34 and 35 which are resilient around cable which is to be fixed to a surface. This embodiment may be beneficial where contact between the cable and the surface is not desired, or where removal of the elongate member without removal of the clip from the surface is desired.

Although the embodiments of FIGS. 12 to 16 are described and illustrated to show envisaged alternatives, the embodiment of FIGS. 1 to 10 is preferred. Although the attachment lugs 90 may be provided at any desired and convenient point on each clip 20, it is preferred that they are provided so that, in use, once a clip 20 is detached, any attachment lug 90 or part of an attachment lug still attached to the clip 20 will be close to the surface to which the clip is attached. This helps to avoid unsightly and possibly hazardous broken plastic elements remaining on the clip 20 where they are likely to be contacted by other objects.

It should be appreciated that various other changes and modifications made to the embodiments described without departing from the spirit or scope of the invention.

1. An array of clips comprising:
a first clip and a second clip; and
a connection element extending between the first clip and the second clip;
each clip having:
a channel for location of a elongate member, and
an abutment fulcrum portion formed on said clip;
wherein rotation of the first clip with respect to the second clip causes the abutment fulcrum portion of the first clip to abut against the second clip to break said connection element.

2. The array of clips of claim 1 wherein the channel may be formed from two legs interconnected by a retaining body.

3. The array of clips of claim 2 wherein the connection element is attached to one leg of each of the clips.

4. The array of clips of claim 2 wherein at least one of the legs of at least one clip includes a widened portion towards an end of the leg to slightly narrow an open side of the channel.

5. The array of clips of claim 2 wherein at least one abutment fulcrum portion on at least one clip protrudes from the clip.

6. The array of clips of claim 2 wherein each leg of each clip has an abutment fulcrum portion.

7. The array of clips of claim 2 wherein the abutment fulcrum portion is in the form of an abutment ear.

8. The array of clips of claim 2 wherein the retaining body of each clip includes a protruding portion that extends into the channel.

9. The array of clips of claim 8 wherein, the protruding portion comprises a ridge which stands proud of the retaining body.

10. The array of clips of claim 2 wherein a securing member extends through a leg of each of the clips.

11. The array of clips of claim 10 wherein the securing member is a nail.

12. The array of clips of claim 2 wherein the connection element is an attachment lug.

13. The array of clips of claim 2 wherein the connection element has a notch located adjacent to where the connection element is attached to the clip.

14. A method of installation of an array of clips, the method including the steps of:
placing a elongate member within a channel of a first clip;
fixing the first clip to a surface to retain the elongate member in a desired position on said surface;
rotating a second clip with respect to the first clip to cause the abutment fulcrum portion, located on either of said first clip or said second clip, to abut against the other of said first clip or said second clip to break a connection element connecting said first clip and said second clip.

15. The method of claim 14 wherein the first clip is separated from the other second clip before or after being fixed to the surface.

16. The method of claim 14 wherein the method includes use of an array of clips in accordance with claim 1.
